(19) United States
(12) Patent Application Publication
(10) Pub. No.: US 2025/0379445 A1
(43) Pub. Date: Dec. 11, 2025

(54) DARK START SUPPORT VERIFICATION

(71) Applicant: FORD GLOBAL TECHNOLOGIES, LLC, Dearborn, MI (US)

(72) Inventors: Richard Mo, Canton, MI (US); Zdravko Nikolik, Tecumseh (CA); Patrick Soderborg, Dexter, MI (US); Timothy Harris, Grosse Ile, MI (US); Kevin Stinnette, Monroe, MI (US); Mukta Darekar, Dearborn, MI (US)

(21) Appl. No.: 18/736,616

(22) Filed: Jun. 7, 2024

(51) Int. Cl. H02J 3/32; B60L 53/14; B60L 55/00

(52) U.S. Cl. CPC H02J 3/322; B60L 53/14; B60L 55/00; H02J 2207/20; H02J 2310/48

(57) ABSTRACT

A combiner box, provided grid power is available to the combiner box and the combiner box is connected with electric vehicle supply equipment, disables a main power converter of the combiner box, enables a reserve power converter of the combiner box, and sends a signal to the electric vehicle supply equipment. This results in a main power converter of the electric vehicle supply equipment being disabled, a reserve power converter of the electric vehicle supply equipment being enabled, and power from a reserve power source of the combiner box, that provides power to start a home energy system when the grid power is unavailable, flowing to the electric vehicle supply equipment.

### TECHNICAL FIELD

This disclosure relates to power management.

### BACKGROUND

An electric vehicle may be one of several power sources that provides backup power to a home when the grid becomes unavailable.

### SUMMARY

A home energy system includes a combiner box that, provided grid power is available to the combiner box and the combiner box is connected with electric vehicle supply equipment, disables a main power converter of the combiner box, enables a reserve power converter of the combiner box, and sends a signal to the electric vehicle supply equipment such that a main power converter of the electric vehicle supply equipment is disabled, a reserve power converter of the electric vehicle supply equipment is enabled, and power from a reserve power source of the combiner box, that provides power to start the home energy system when the grid power is unavailable, flows to the electric vehicle supply equipment.

A method includes, responsive to occurrence of a predefined condition while grid power is available to a combiner box and the combiner box is connected with electric vehicle supply equipment, disabling a main switch mode power supply of the combiner box, enabling a reserve switch mode power supply of the combiner box, and sending a signal to the electric vehicle supply equipment such that the electric vehicle supply equipment consumes power from a battery of the combiner box, that provides power to start a home energy system including the combiner box when the grid power is unavailable, via Power over Ethernet.

A combiner box includes main and reserve switch mode power supplies, a battery that provides power to start a home energy system that includes the combiner box, and a microprocessor that, while grid power is available to the combiner box and the combiner box is connected with electric vehicle supply equipment, disables the main switch mode power supply, enables the reserve switch mode power supply, and then supplies power from the battery to the electric vehicle supply equipment.

### BRIEF DESCRIPTION OF THE DRAWINGS

FIG. 1 is a schematic diagram of a home energy system.

FIG. 2 is a schematic diagram of portions of the home energy system of FIG. 1.

FIG. 3 is a flowchart of an algorithm for checking the operational readiness of certain components of the home energy system of FIG. 1.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Verification of voltage of supporting devices in electric vehicle supply equipment (EVSE) and combiner box dark start battery configurations during power outages is described. Proposed strategies include a periodic test that can be performed while the grid is powering the home, ensuring that each system can receive the required DC power even during power outages. In an example, several steps are executed after meeting the entry conditions, which may include a grid-tied system, the grid powering the home, communications established between the combiner box and EVSE, communications established to the cloud, and/or a predetermined number of days since the last dark start battery check. The first step may involve disabling the combiner box's main switch mode power supply (SMPS) and enabling its dark start battery SMPS, followed by the combiner box sending a dark start battery check signal to the EVSE. The EVSE disables its SMPS and consumes dark start battery power via Power over Ethernet (POE). Then, the combiner box checks its dark start battery voltage/current, and the EVSE checks its dark start battery voltage/current. If both tests pass, the test is ended. This ensures that each system can receive the required DC power during power outages, and it is achieved by disabling the SMPS and enabling the dark start battery circuit for power. Both the combiner box and EVSE monitor their input voltage during the test. After a predetermined amount of time, the dark start battery circuit is disabled, and the SMPS is enabled.

Combiner boxes are components in some home backup energy systems that incorporate a variety of energy sources, such as solar panels, wind turbines, generators, and vehicle-to-grid systems. These boxes function primarily to aggregate outputs from these multiple energy-generating sources into a single electrical output. This consolidated output can then be channeled into an inverter or a central controller, simplifying the management of various inputs.

Combiner boxes can be equipped with several components including overcurrent protection devices such as fuses or circuit breakers that shield the wiring and other components from potential over currents due to faults or mismatches in panel outputs. Additionally, surge protection devices within these boxes help guard against voltage spikes that are often caused by lightning strikes or disruptions in the grid. Disconnect switches are also included to allow for the manual disconnection of energy sources for system maintenance or other checks. Moreover, modern combiner boxes may incorporate voltage and current sensors on each input to facilitate the monitoring and optimization of performance for each energy source, aiding in fault diagnosis and system management.

Combiner boxes control AC power flow from multiple AC sources, such as photovoltaic inverters, electric vehicles, and stationary battery inverters, to one AC bus that can be tapped or sourced by AC loads including a home, high voltage energy storage devices, or the grid.

When integrated into home energy systems, combiner boxes enable the output from solar panels or other energy sources to be aggregated for use in home appliances, battery storage, or feeding back into the grid. An external inverter, which may be separate from the combiner box, is for managing the energy flow to and from the battery storage system. Combiner aggregation allows for energy storage during low usage periods and its utilization during peak demand or low generation times. Combiner boxes also facilitate the integration of generators and vehicle-to-grid systems as supplementary inputs, possibly optimizing the energy usage based on availability or economic considerations, such as using stored battery power during peak grid prices.

Systems equipped with grid-tied inverters can send excess power back to the public grid, generating credits or revenue for homeowners. These systems can also participate in demand response services, helping to stabilize the grid by adjusting their energy consumption or supplying stored energy during peak periods. Enhanced by Internet of Things technology, modern combiner boxes can be integrated into larger energy management systems that optimize home energy usage. Homeowners can monitor their energy systems in real-time through smartphone applications or computer software, assessing everything from the output of individual solar panels to the status of batteries and the overall efficiency of the system.

A SMPS is a power conversion device. Unlike traditional linear power supplies that dissipate excess voltage as heat to control output, SMPSs switch on and off rapidly to control the amount of energy delivered to the load, thereby minimizing energy loss. This switching action is managed by a semiconductor device, typically a transistor, which alternates between low and high impedance states, effectively controlling the voltage and current delivered to the load.

The operation of an SMPS may involve several stages. The AC mains voltage is first rectified to produce a high-voltage DC, which is then converted to a high-frequency AC through the switching action of the transistor. This high-frequency AC is then transformed to the desired voltage level using a small transformer. After transformation, the AC is rectified again to produce a stable DC output. The output voltage is controlled by adjusting the duty cycle of the switching transistor, which is the proportion of time that the transistor is conducting versus the time it is off. This control is achieved through feedback mechanisms that continuously monitor the output and adjust the switching accordingly to maintain a constant output voltage regardless of changes in input voltage or load conditions.

SMPSs can accommodate a wide range of input voltages. The relatively fast response time of SMPSs to changing load conditions and their ability to provide features such as overvoltage protection, current limiting, and thermal shutdown further contribute to their robustness.

The function of EVSE is not merely to supply electricity but to communicate with the electric vehicle to coordinate the charging process. This may involve a communication protocol that confirms the electrical connection's integrity, identifies the maximum current capacity of the electric vehicle's onboard charger, and ensures that the vehicle is properly connected and ready to receive power before charging begins. The EVSE can manage the power delivery to the vehicle, modulating current flow and monitoring the connection for faults or sudden disconnects.

EVSE varies in terms of the charging levels it offers, which are categorized mainly into three levels based on the power output and the charging speed. Level 1 charging is the slowest form, using a standard 120-volt AC outlet commonly found in home settings. It delivers around 1.4 kW of power and is typically used for overnight charging, providing roughly 4 to 5 miles of range per hour of charging. Level 2 charging uses a 240-volt AC supply, similar to what large household appliances use. It significantly increases charging speed, offering about 15 to 70 miles of range per hour of charging with power outputs ranging from 3 kW to 22 kW. The fastest type, Level 3, also known as DC fast charging, uses a direct current (DC) supply of up to 400 volts or more, providing power levels upwards of 50 kW and up to 350 kW in some installations. This can charge an electric vehicle battery to 80% capacity in as little as 20 minutes.

Some EVSE has features that integrate into smart grid technology, offering functionalities like scheduled charging during off-peak electricity rate periods, remote control and monitoring via smartphone applications, and integration with home energy management systems. This smart connectivity may support grid stability by allowing electric vehicles to function as grid resources. In vehicle-to-grid setups, electric vehicles can return energy to the grid, helping to balance supply and demand dynamics.

Features in some EVSE may include ground fault circuit interrupter protection and connectivity checks that ensure the charger is communicating with the vehicle before and during the charging process.

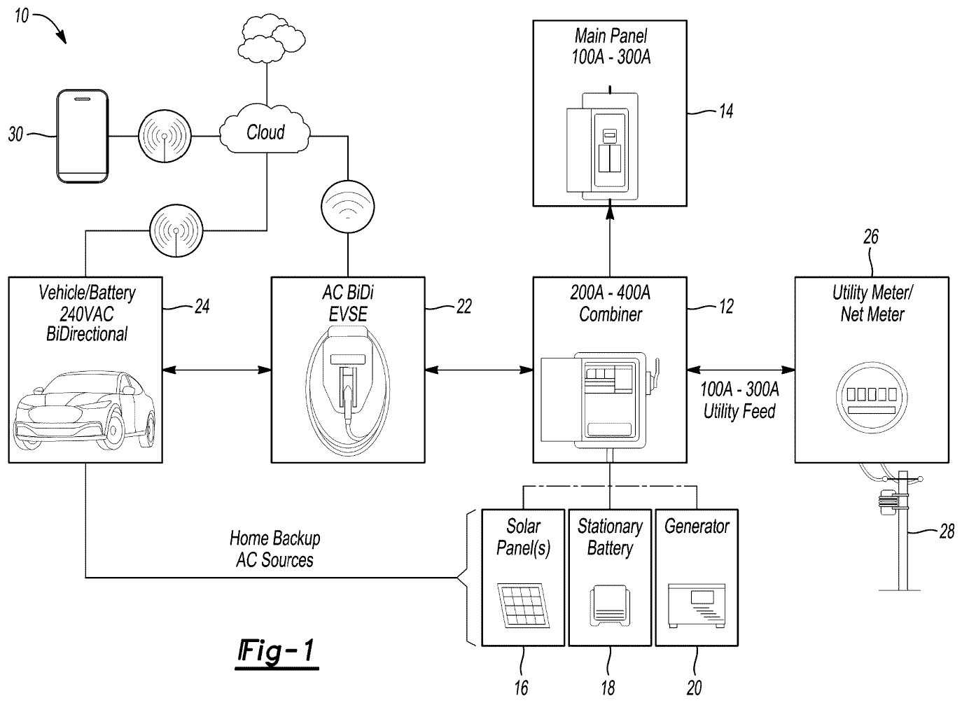

Referring to FIG. 1, an example home energy system 10 includes a combiner box 12, a main panel 14, which is associated with a home, solar panels 16, a stationary battery 18, a generator 20, EVSE 22, and an electric vehicle 24, which includes a traction battery and bidirectional power capabilities. The combiner box 12 is connected with a utility meter 26 of a grid 28 and connected between the main panel 14 and the solar panels 16, stationary battery 18, and generator 20. The combiner box 12 may also be connected with the electric vehicle 24 via the EVSE 22. In this arrangement, the solar panels 16, stationary battery 18, generator 20, and electric vehicle 24 are backup sources for the home. The EVSE 22 and electric vehicle 24 may be in communication with a mobile device 30 (e.g., cell phone) via cloud services, etc. When the grid 28 becomes unavailable, the combiner box 12 isolates from the grid 28, communicates with the backup sources for the home, and controls AC power flow to back up the home.

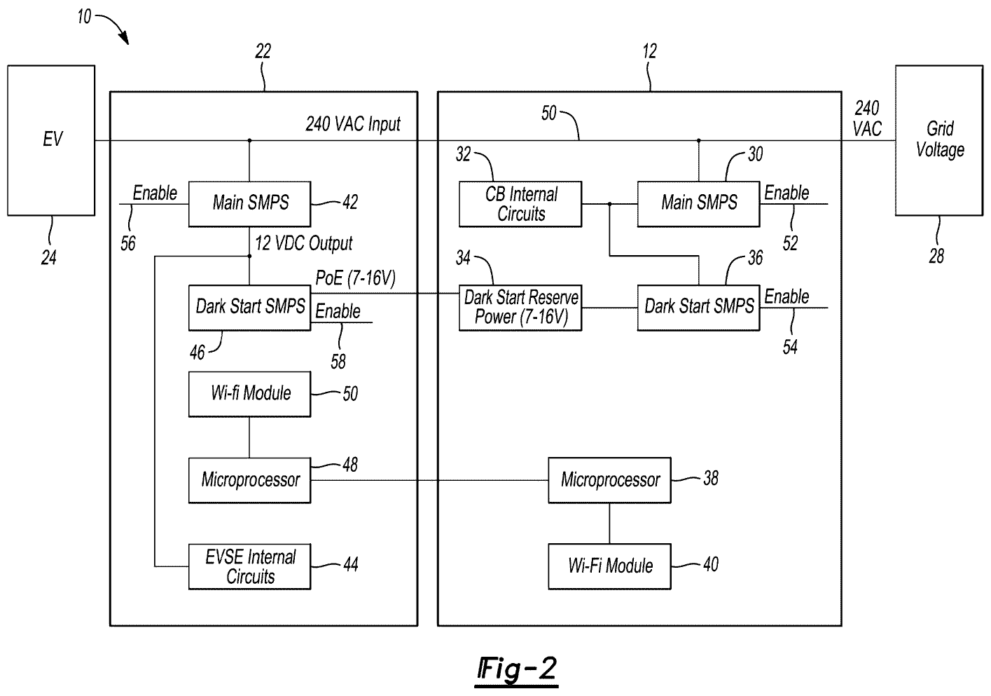

Referring to FIG. 2, the combiner box 12 includes a main SMPS 30, internal circuits 32, a reserve (or dark start) power source 34 (e.g., a 12V battery, etc.), a reserve (or dark start) SMPS 36, a controller including a microprocessor 38, and a communications module 40 (e.g., a Wi-Fi module, etc.). The EVSE 22 includes a main SMPS 42, internal circuits 44, a reserve (or dark start) SMPS 46, a controller including a microprocessor 48, and a communications module 50 (e.g., a Wi-Fi module etc.). The reserve power source 34 aids in the process of starting up certain components of the home energy system 10 when power from the grid 28 is unavailable. It, for example, powers components of the combiner box 12 and EVSE 22 when the electric vehicle 24 is not present while the grid 28 is unavailable.

When the EVSE 22 is electrically connected with the combiner box 12 and electric vehicle 24, a continuous AC line 50 is established between the electric vehicle 24 and grid 28. The main SMPS 30 is electrically connected with the AC line 50. The main SMPS 30, internal circuits 32, and reserve SMPS 36 are electrically connected together. And the reserve power source 34 and reserve SMPS 36 are electrically connected together. The microprocessor 38 is in communication with the communications module 40 and may exert control over components of the combiner box 12 via, for example, the enable lines 52, 54 associated with the main SMPS 30 and reserve SMPS 36, respectively.

The main SMPS 42 is electrically connected with the AC line 50. The main SMPS 42, internal circuits 44, and reserve SMPS 46 are electrically connected together. The microprocessor 48 is in communication with the communications module 50 and may exert control over components of the EVSE 22 via, for example, the enable lines 56, 58 associated with the main SMPS 42 and reserve SMPS 46, respectively.

The reserve power source 34 and reserve SMPS 46 are connected via an Ethernet connection such that PoE energy transfer occurs between the two. Moreover, the microprocessors 38, 48 are connected via a communication link.

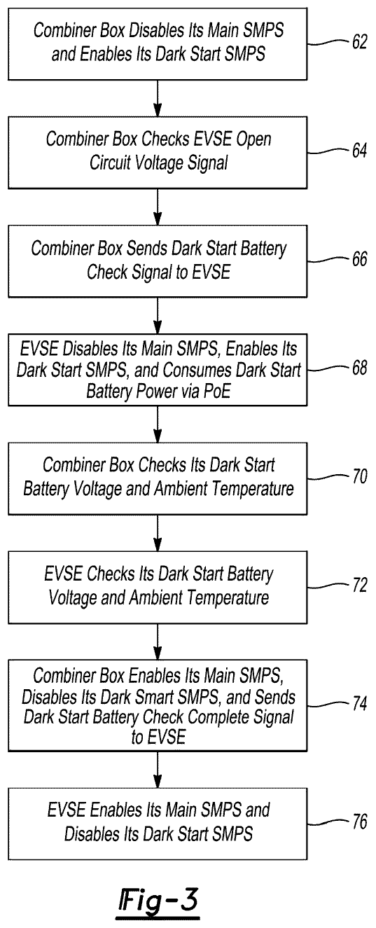

Referring to FIGS. 1, 2, and 3, proper operation of the reserve power source 34 and related components may be periodically checked. This may be performed, for example, when the grid 28 is available and powering the home, communications between the combiner box 12 and EVSE 22 are established, communications between the EVSE 22, electric vehicle 24, and cloud are established, and/or a predetermined time period (e.g., 3 days, 7 days) has passed since the last operational check.

At operation 60, the main SMPS 30 is disabled by setting the enable line 52 to ‘0’ and the reserve SMPS 36 is enabled by setting the enable line 54 to ‘1.’ At operation 62, an open circuit voltage of the EVSE 22 is checked via voltage and/or current sensors associated with the internal circuits 32 and arranged in known fashion to sense such parameters. This check will pass if the open circuit voltage falls within some predefined range of values. Otherwise, the check will not pass. At operation 64, the combiner box 12 communicates its intention to check its reserve power source 34 to the EVSE 22 via the communication link between the microprocessors 38, 48. Responsive thereto, the main SMPS 42 is disabled by setting the enable line 56 to ‘0,’ the SMPS 46 is enabled by setting the enable line 58 to ‘1,’ and the EVSE 22 consumes energy from the reserve power source 34 via PoE at operation 66. At operation 68, a voltage of the reserve power source 34 and ambient temperature is checked via voltage and temperature sensors associated with the internal circuits 32 and arranged in known fashion to sense such parameters. Current may also be checked via current sensors associated with the internal circuits 32 and arranged in known fashion to sense such parameters. The voltage check will pass if the voltage falls within some predefined range of values. Otherwise, the check will not pass, and a message may be sent to the mobile device 30 via the communications module 40 and cloud. The ambient temperature check will pass if the temperature falls within some predefined range of values. Otherwise, the check will not pass, and a message may be sent to the mobile device 30 via the communications module 40 and cloud. At operation 70, a voltage from the reserve energy source 34 and ambient temperature is checked via voltage and temperature sensors associated with the internal circuits 44 and arranged in known fashion to sense such parameters. The voltage check will pass if the voltage falls within some predefined range of values (e.g., 7V to 16V). Otherwise, the check will not pass, and a message may be sent to the mobile device 30 via the communications module 50 and cloud. The ambient temperature check will pass if the temperature falls within some predefined range of values. Otherwise, the check will not pass, and a message may be sent to the mobile device 30 via the communications module 50 and cloud. At operation 72, the main SMPS 30 is enabled by setting the enable line 52 to ‘1,’ the reserve SMPS 36 is disabled by setting the enable line 54 to ‘0,’ and the combiner box 12 communicates that the check of its reserve power source 34 is complete to the EVSE 22 via the communication link between the microprocessors 38, 48. At operation 74, the main SMPS 42 is enabled by setting the enable line 56 to ‘1’ and the reserve SMPS 46 is disabled by setting the enable line 58 to ‘0,’ which concludes the operational check. The EVSE 22 no longer consumes energy from the reserve power source 34 via PoE.

The algorithms, methods, or processes disclosed herein can be deliverable to or implemented by a computer, controller, or processing device, such as the microprocessors 38, 48, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Power converters other than SMPSs, such as fly-back converters, etc., may be used. Technologies other than PoE may permit power flow between combiner boxes and EVSE, etc. Moreover, the words used in the specification are words of description rather than limitation, and it is understood that various changes may be made without departing from the spirit and scope of these disclosed materials. “Controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A home energy system comprising:
a combiner box configured to, provided grid power is available to the combiner box and the combiner box is connected with electric vehicle supply equipment, disable a main power converter of the combiner box, enable a reserve power converter of the combiner box, and send a signal to the electric vehicle supply equipment such that a main power converter of the electric vehicle supply equipment is disabled, a reserve power converter of the electric vehicle supply equipment is enabled, and power from a reserve power source of the combiner box, configured to provide power to start the home energy system when the grid power is unavailable, flows to the electric vehicle supply equipment.

2. The home energy system of claim 1, wherein the combiner box is further configured to, after the power flows to the electric vehicle supply equipment, enable the main power converter of the combiner box and disable the reserve power converter of the combiner box.

3. The home energy system of claim 1, wherein the combiner box is further configured to, after the power flows to the electric vehicle supply equipment, send a signal to the electric vehicle supply equipment such that the main power converter of the electric vehicle supply equipment is enabled, the reserve power converter of the electric vehicle supply equipment is disabled, and the power from the reserve power source of the combiner box no longer flows to the electric vehicle supply equipment.

4. The home energy system of claim 1, wherein the power from the reserve power source of the combiner box flows to the electric vehicle supply equipment via Power over Ethernet.

5. The home energy system of claim 1, wherein the reserve power source of the combiner box is a battery.

6. The home energy system of claim 1, wherein the combiner box is further configured to send a signal related to voltage or current of the power.

7. The home energy system of claim 1, wherein the combiner box is further configured to send a signal related to ambient temperature.

8. The home energy system of claim 1, wherein the main and reserve power converters of the combiner box are switch mode power supplies.

9. The home energy system of claim 1, wherein the main and reserve power converters of the electric vehicle supply equipment are switch mode power supplies.

10. A method comprising:
responsive to occurrence of a predefined condition while grid power is available to a combiner box and the combiner box is connected with electric vehicle supply equipment, disabling a main switch mode power supply of the combiner box, enabling a reserve switch mode power supply of the combiner box, and sending a signal to the electric vehicle supply equipment such that the electric vehicle supply equipment consumes power from a battery of the combiner box, configured to provide power to start a home energy system including the combiner box when the grid power is unavailable, via Power over Ethernet.

11. The method of claim 10 further comprising sending the signal such that a main switch mode power supply of the electric vehicle supply equipment is disabled, and a reserve switch mode power supply of the electric vehicle supply equipment is enabled.

12. The method of claim 11 further comprising after the electric vehicle supply equipment consumes the power, sending another signal to the electric vehicle supply equipment such that the main switch mode power supply of the electric vehicle supply equipment is enabled, and the reserve switch mode power supply of the electric vehicle supply equipment is disabled.

13. The method of claim 10 further comprising sending a signal related to voltage or current of the power.

14. The method of claim 10 further comprising sending a signal related to ambient temperature.

15. A combiner box comprising:
main and reserve switch mode power supplies;
a battery configured to provide power to start a home energy system that includes the combiner box; and
a microprocessor programmed to, while grid power is available to the combiner box and the combiner box is connected with electric vehicle supply equipment, disable the main switch mode power supply, enable the reserve switch mode power supply, and then supply power from the battery to the electric vehicle supply equipment.

16. The combiner box of claim 15, wherein the microprocessor is further programmed to supply the power via Power over Ethernet.

17. The combiner box of claim 15, wherein the microprocessor is further programmed to enable the main switch mode power supply and disable the reserve switch mode power supply provided that parameters derived from the power are within predefined ranges.

18. The combiner box of claim 15, wherein the battery is a 12V battery.

19. The combiner box of claim 15, wherein the microprocessor is further programmed to send a signal regarding a voltage or current of the power.

20. The combiner box of claim 15, wherein the microprocessor is further programmed to send a signal regarding ambient temperature.
